(19) United States
(12) Patent Application Publication
(10) Pub. No.: US 2009/0066247 A1
(43) Pub. Date: Mar. 12, 2009

(54) Plasma display panel

(76) Inventor: Jung-Suk Song, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/230,107

(22) Filed: Aug. 22, 2008

(30) Foreign Application Priority Data
Sep. 10, 2007 (KR) 10-2007-0091641

(51) Int. Cl. H01J 17/49

(52) U.S. Cl. 313/582

(57) ABSTRACT

A plasma display panel that can reduce electrode-defects, and can improve efficiency. The plasma display panel includes a first substrate and a second substrate that are spaced apart from each other; barrier ribs dividing a space between the first substrate and the second substrate into a plurality discharge cells; transparent electrodes disposed between the barrier ribs and the first substrate, wherein each of the transparent electrodes comprises a first extension unit and a second extension unit that extend to cross the respective discharge cells, and a connection unit connecting the first extension unit to the second extension unit, and at least a part of the connection unit is disposed on the barrier ribs.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 10 Sep. 2007 and there duly assigned Serial No. 10-2007-0091641.

### BACKGROUND OF THE INVENTION

1. Field of the Invention

The present invention relates to a plasma display panel, and more particularly, to a plasma display panel including electrodes that are disposed in respective discharge cells, in which power is supplied to the respective electrodes, discharge is generated in the discharge cells, and an image is formed.

2. Description of the Related Art

Plasma display panels (PDPs), which are being used as a replacement for conventional cathode ray tubes (CRTs), are display devices that display images by applying a discharge voltage to a plurality of electrodes formed on substrates in order to generate ultraviolet (UV) rays that excite phosphor layers arranged in a predetermined pattern.

Conventional alternating current (AC) PDPs include an upper plate that displays an image, and a lower plate that is coupled with and parallel to the upper plate. The front substrate of the upper plate includes sustain electrode pairs arranged thereon. The rear substrate of the lower plate includes address electrodes arranged on a surface facing the surface of the front substrate on which the sustain electrode pairs are arranged. The address electrodes intersect, without contacting, the sustain electrode pairs.

A first dielectric layer and a second dielectric layer are respectively formed on the surface of the front substrate on which the sustain electrode pairs are arranged, and on the surface of the rear substrate on which the address electrodes are arranged. The sustain electrode pairs and the address electrodes are embedded in the first and second dielectric layers respectively. Barrier ribs, for maintaining a discharge distance between the opposing substrates and preventing optical cross-talk between discharge cells, are arranged on the front surface of the second dielectric layer.

Red, green, and blue phosphors are appropriately coated on sidewalls of the barrier ribs and on the front surface of the second dielectric layer.

Each of the sustain electrode pairs includes a transparent electrode and a bus electrode. The transparent electrode is formed of a conductive material capable of generating a discharge and is transparent so as to allow light emitted from the phosphors to propagate toward the front substrate. The transparent material may be indium tin oxide (ITO) or the like. The bus electrode is conventionally a metal electrode having a high electric conductivity.

### SUMMARY OF THE INVENTION

The number and the size of discharge cells with respect to the same-sized panel are respectively increased and reduced in order to realize fine pitch and high resolution. In this case, the size of a transparent electrode disposed in a discharge space of each discharge cell is reduced to thereby increase ITO-based defects such as dim spot, or the like.

In addition, when the size of a transparent electrode disposed in a respective discharge cell is increased, and thus an area of the discharge cell, which is hidden by the transparent electrode, is increased, discharge efficiency can be reduced.

The present invention provides a plasma display panel that can reduce electrode-defects, and can improve efficiency.

According to an aspect of the present invention, there is provided a plasma display panel comprising: a first substrate and a second substrate that are spaced apart from each other; barrier ribs dividing a space between the first substrate and the second substrate into a plurality discharge cells; and transparent electrodes disposed between the barrier ribs and the first substrate, wherein each of the transparent electrodes comprise a first extension unit and a second extension unit that extend to cross the respective discharge cells, and a connection unit connecting the first extension unit to the second extension unit, and at least a part of the connection unit is disposed on the barrier ribs.

The first extension unit and the second extension unit may extend substantially parallel to each other.

Each of the barrier ribs may comprise a horizontal barrier rib extending in a direction in which the first extension unit and the second extension unit extend, and a vertical barrier rib extending in a different direction from the direction in which the horizontal barrier rib extends.

At least a part of the first extension unit may be disposed on the horizontal barrier rib.

According to an aspect of the present invention, there is provided a plasma display panel comprising: a first substrate and a second substrate that are spaced apart from each other; X electrodes and Y electrodes that are disposed between the first substrate and the second substrate, and that extend in one direction; address electrodes that are disposed between the first substrate and the second substrate, and that extend in a different direction from a direction in which the X electrodes and the Y electrodes extend; barrier ribs dividing a space between the first substrate and the second substrate into a plurality discharge cells; a first dielectric layer disposed on the first substrate so as to cover the X electrodes and the Y electrodes; and a second dielectric layer disposed on the second substrate so as to cover the address electrodes, wherein each of the X electrodes and the Y electrodes comprises a transparent electrode and a bus electrode, the transparent electrode comprises a first extension unit and a second extension unit that respectively extend in directions in which the X electrodes and the Y electrodes extend; and a connection unit connecting the first extension unit to the second extension unit, wherein at least a part of the connection unit is disposed on the barrier ribs.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a partial exploded perspective view of a plasma display panel according to an embodiment of the present invention;

FIG. 2 is a cross-sectional view of the plasma display panel taken along a line II-II of FIG. 1; and

FIG. 3 is a schematic view illustrating an arrangement of barrier ribs and electrodes of the plasma display panel of FIG. 1.

### DETAILED DESCRIPTION OF THE INVENTION

Hereinafter, the present invention will be described in detail by explaining exemplary embodiments of the invention with reference to the attached drawings.

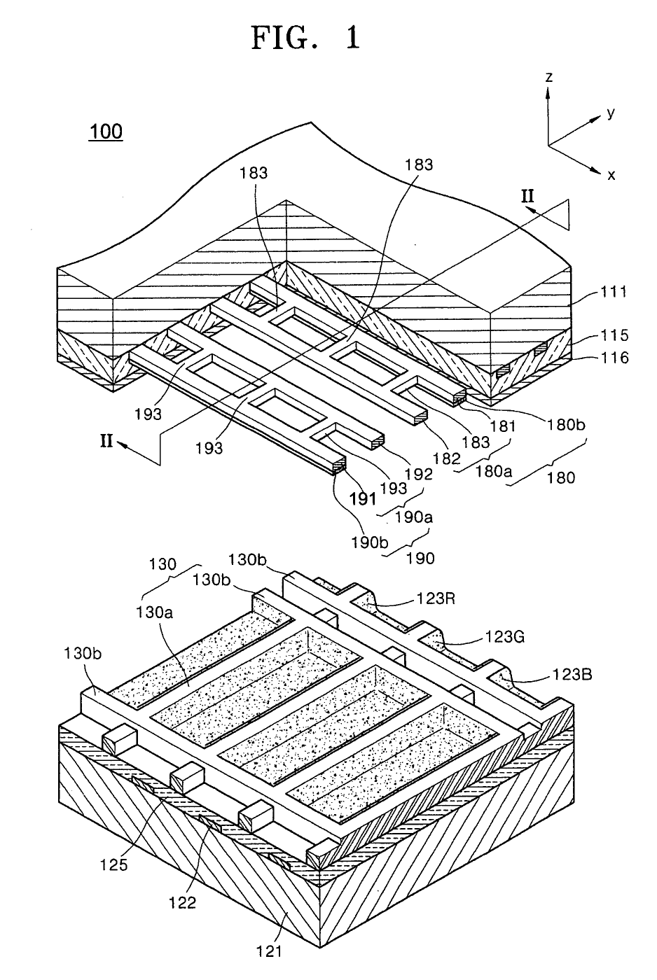

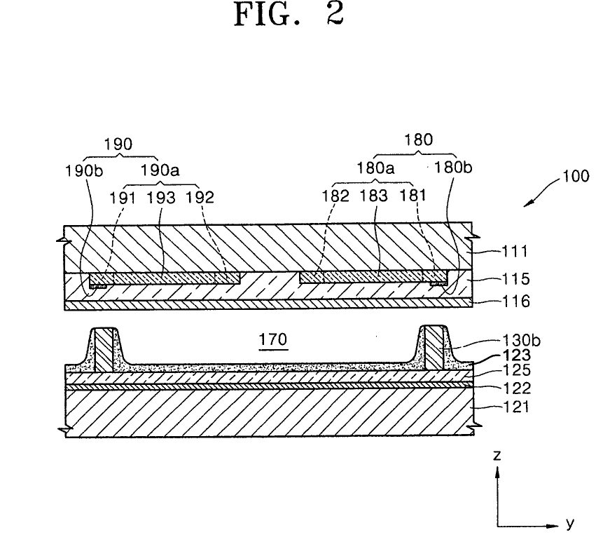

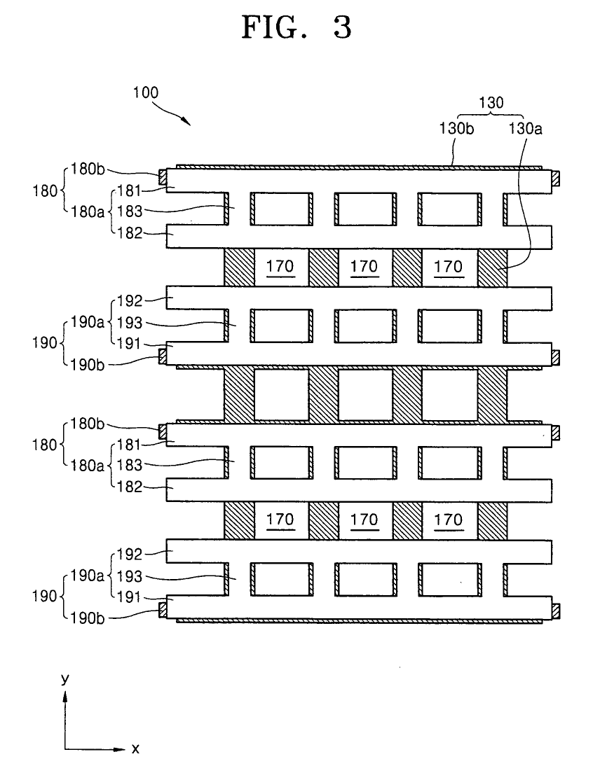

FIG. 1 is a partial exploded perspective view of a plasma display panel 100 according to an embodiment of the present invention. FIG. 2 is a cross-sectional view of the plasma display panel 100 taken along a line II-II of FIG. 1. FIG. 3 is a schematic view illustrating an arrangement of barrier ribs 130 and electrodes 180 and 190 of the plasma display panel 100 of FIG. 1.

Referring to FIGS. 1 through 3, the plasma display panel 100 according to the current 111 embodiment of the present invention is illustrated. The plasma display panel 100 includes a first substrate, a second substrate, a pair of sustain electrodes 180 and 190, address electrodes 122, barrier ribs 130, a protective layer 116, a phosphor layer 123, a first dielectric layer, a second dielectric layer, and a discharge gas (not shown).

The first substrate is a top substrate 111, and the second substrate is a bottom substrate 121. The pair of sustain electrodes 180 and 190 may respectively include an X electrode 180 and a Y electrode 190 between which sustain discharge is generated. A data pulse is applied the address electrodes 122 so as to select a discharge cell in which a sustain discharge is to be generated. The first dielectric layer is a top dielectric layer 115, and the second dielectric layer is a bottom dielectric layer 125.

The top substrate 111 and the bottom substrate 121 are spaced apart from each other at a predetermined interval, and define a discharge space generating discharge. The top substrate 111 and the bottom substrate 121 may be formed of glass or the like having good transmissivity of visible light. However, to improve bright room contrast, the top substrate 111 and/or the bottom substrate 121 maybe colored.

The barrier ribs 130 are formed between the top substrate 111 and the bottom substrate 121, and are formed on the bottom dielectric layer 125. Accordingly, the barrier ribs 130 are formed between the top dielectric layer 115 and the bottom dielectric layer 125. When the protective layer 116 is formed on the top dielectric layer 115, the barrier ribs 130 are formed between the protective layer 116 and the bottom dielectric layer 125.

The barrier ribs 130 divide the discharge space into a plurality of discharge cells 170, and prevent optical/electric cross-talk between the discharge cells 170.

The barrier ribs 130 are illustrated to divide the discharge space into the matrix-arrayed discharge cells 170 each having a sectional shape of a quadrangle in FIG. 1, however, the present invention is not limited thereto. That is, barrier ribs 130 are formed so that each of the discharge cells 170 may have a sectional shape of a polygon (e.g., a triangle, a pentagon or the like), a circle, an oval, or the like, and may be formed to have an open-shape (e.g., a stripe). The barrier ribs 130 may divide the discharge space into the discharge cells 170 in a waffle or delta array.

In this case, the barrier ribs 130 may include vertical barrier ribs 130a and horizontal barrier ribs 130b. In FIGS. 1 through 3, they-axis direction is a horizontal direction, and the vertical barrier ribs 130a extend in the horizontal direction. In this case, each of the respective discharge cells 170 can be defined by the pair of vertical barrier ribs 130a, which are adjacent to each other in the x-axis direction, and the pair of horizontal barrier ribs 130b, which are adjacent to each other in the y-axis direction.

In addition, since the two horizontal barrier ribs 130b are disposed between the discharge cells 170, which are adjacent to each other in the y-axis direction in which the vertical barrier ribs 130a extends, the plasma display panel 100 can be formed in a double barrier rib structure.

The pair of sustain electrodes 180 and 190 are disposed on the top substrate 111 facing the bottom substrate 121. The pair of sustain electrodes 180 and 190 are formed on the bottom surface of the top substrate 111, and are disposed parallel to each other on the top substrate 111.

One sustain electrode of the pair of sustain electrodes 180 and 190 is an X electrode 180, and functions as a common electrode. The other sustain electrode of the pair of sustain electrodes 180 and 190 is a Y electrode 190, and functions as a scanning electrode. The pair of sustain electrodes 180 and 190 are illustrated as being disposed on the top substrate 111 in FIGS. 1 through 3, however, the present invention is not limited thereto.

In addition, a three-electrode structure is illustrated in FIGS. 1 through 3, however, the present invention is not limited thereto. That is, a two-electrode structure, in which the sustain electrodes 180 and 190 are respectively configured in one electrode, can be embodied in the present invention. Alternatively, only one of the X electrode 180 and the Y electrode 190 may be disposed each between the barrier ribs 130 and the top substrate 111.

The X electrode 180 and the Y electrode 190 include transparent electrodes 180a and 190a and bus electrodes 180b and 190b, respectively. The transparent electrodes 180a and 190a are formed of a transparent material that is an electric conductor generating discharge and that does not prevent light emitted from the phosphor 123 from proceeding towards the top substrate 111. An example of the transparent material is indium tin oxide (ITO).

However, a transparent electric conductor such as ITO has a great resistance. Thus, when both the sustain electrodes 180 and 190 are transparent electrodes, voltage drop can be great in a lengthwise direction, thereby increasing driving power and extending a response time. To resolve this problem, the bus electrodes 180b and 190b formed of metal are disposed so as to be electrically connected to the transparent electrodes 180a and 190a.

The shapes and arrangement of the X electrode 180 and the Y electrode 190 will now be described in more detail. The bus electrodes 180b and 190b are spaced apart in a direction parallel to the discharge cells 170, and may extend to cross the discharge cells 170. One side of each of the transparent electrodes 180a and 190a is connected to the bus electrodes 180b and 190b, respectively, and the other sides of the transparent electrodes 180a and 190a are disposed so as to face the center of the discharge cells 170.

As illustrated in FIGS. 1 through 3, the X electrode 180 and the Y electrode 190 are disposed in the adjacent discharge cells 170 in an order of the X electrode 180—the Y electrode 190—the X electrode 180—the Y electrode 190. That is, the X electrode 180 and the Y electrode 190 are disposed in each of the discharge cells 170 in an order of the X electrode 180—the Y electrode 190, and are disposed in all of the discharge cells 170 in that order.

Each indicating (display) line is defined by the pair of sustain electrodes 180 and 190 that include the X electrode 180 and the Y electrode 190.

Alternatively (not shown), the X electrodes may be disposed so as to be adjacent to each other in the adjacent indicating lines. In this case, the X electrodes may be disposed so as to share the bus electrodes of the X electrodes, and so that the transparent electrode corresponding to each indicating line may extend in a direction of a discharge cell corresponding to each indicating line.

The top dielectric layer 115 is formed on the top substrate 111 so as to cover the pair of sustain electrodes 180 and 190. The top dielectric layer 115 prevents the X electrode 180 and the Y electrode 190 that are adjacent to each other from being electrically connected, and prevents charged particles or electrons from directly colliding with the X electrode 180 and the Y electrode 190 to damage the X electrode 180 and the Y electrode 190. In addition, the top dielectric layer 115 induces electric charges. The top dielectric layer 115 is formed of PbO, B₂O₃, SiO₂ or the like.

The plasma display panel 100 may further include the protective layer 116 covering the top dielectric layer 115. The protective layer 116 prevents charged particles or electrons from colliding with the top dielectric layer 115 to damage the top dielectric layer 115 during discharge.

The protective layer 116 is disposed so as to cover a surface of the top dielectric layer 115, which faces the discharging cells 170. As illustrated in FIG. 1, the protective layer 116 is disposed on the top dielectric layer 115, and the top dielectric layer 115 is disposed on the top substrate 111 so as to cover the X electrode 180 and the Y electrode 190, however, the present invention is not limited thereto. A protective layer may be disposed on the bottom dielectric layer 125 or the barrier ribs 130.

In addition, the protective layer 116 emits secondary electrons in great quantities during discharge to smooth plasma discharge. The protective layer 116 functioning likewise has a high secondary electron emission coefficient, and is formed of a material having a high transmissivity of visible light. The protective layer 116 may be formed by using sputtering or E-beam evaporation after the top dielectric layer 115 is formed.

The address electrodes 122 are disposed on the surface of the bottom substrate 121 facing the top substrate 111. The address electrodes 122 extend to cross the discharge cells 170 so as to perpendicularly cross the X electrode 180 and the Y electrode 190.

The address electrodes 122 generate address discharge in order to ease sustain discharge between the X electrode 180 and the Y electrode 190 in a corresponding discharge cell in which sustain discharge is to be generated. In particular, the address electrodes 122 lower a voltage for generating the sustain discharge.

The address discharge is generated between the Y electrode 190 and each of the address electrodes 122. When the address discharge is terminated, wall charges accumulate on sides of the Y electrode 190 and the X electrode 180 to thereby ease the sustain discharge between the X electrode 180 and the Y electrode 190.

Each unit discharge cell is defined by a space surrounding the pair of the X electrode 180 and Y electrode 190, and each of the address electrodes 122 crossing the pair of the X electrode 180 and Y electrode 190.

The bottom dielectric layer 125 is formed on the bottom substrate 121 so as to cover the address electrodes 122. The bottom dielectric layer 125 is formed of a dielectric substance so as to prevent charged particles or electrons from colliding with the address electrodes 122 and damaging the address electrodes 122 during discharge, and so as to induce electric charges. Examples of the dielectric substance are PbO, B₂O₃, SiO₂, and the like.

Phosphor layers 123R, 123G and 123B are disposed on both sidewalls of each of the barrier ribs 130, which are formed on the bottom dielectric layer 125, and on front surfaces of the bottom dielectric layer 125, on which the barrier ribs 130 are not formed.

The phosphor layers 123R, 123G and 123B each include a material receiving ultraviolet rays to emit visible rays. The phosphor layer 123R formed in a red emitting discharge cell includes a phosphor such as Y(V,P)O₄:Eu, or the like. The phosphor layer 123G formed in a green emitting discharge cell includes a phosphor such as Zn₂SiO₄:Mn, YBO₃:Tb, or the like. The phosphor layer 123B formed in a blue emitting discharge cell includes a phosphor such as BAM:Eu, or the like.

The discharge cells 170 are filled with discharge gas in which Ne, Xe, He, or the like are mixed. When the discharge cells 170 are filled with discharge gas, the top substrate 111 and the bottom substrate 121 are coupled by a sealing member such as frit glass formed on outer edges of the top substrate 111 and the bottom substrate 121.

When the energy level of discharge gas exited during sustain discharge is lowered, ultraviolet rays are emitted. The ultraviolet rays excite phosphor coated on the inside of the discharge cells 170. When the energy level of the excited phosphor 123 is lowered, visible rays are emitted. When visible rays are transmitted through the top dielectric layer 115 and the top substrate 111 to be emitted, an image, which can be sensed by a user, is formed.

As illustrated in FIG. 1, the X electrodes and the Y electrodes are formed in a ladder type arrangement. In particular, the transparent electrodes 180a and 190a are formed in a ladder type arrangement. The transparent electrodes 180a and 190a include first extension units 181 and 191, second extension units 182 and 192, and connection units 183 and 193. At least a part of the connection units 183 and 193, preferably, the entire connection unit 183 and entire connection unit 193, are disposed on the barrier ribs 130.

The bus electrodes 180b and 190b are disposed on a surface facing one surface of the first extension units 181 and 191, preferably, a surface facing the discharge space so as to extend along the horizontal barrier ribs 130b and so as to be electrically connected to the connection units 183 and 193.

Meanwhile, like a conventional plasma display panel, the number and the size of discharge cells with respect to the same-sized panel are respectively increased and reduced in order to realize fine pitch and high resolution. In this case, the size of a transparent electrode disposed in a discharge space of each discharge cell may be reduced.

Meanwhile, an ITO transparent electrode may be formed of an ITO film configured in a structure in which a PE film-a resin layer-a film layer are stacked in that order. When a protective film is removed from the ITO film, and the resin layer and an ITO layer are compressed to each other, such process may have a problem with the adhesive property between an adhesive protrusion layer and a pattern unit of an ITO, wherein the adhesive protrusion layer is formed when the PE film and the resin layer are coupled. A structure including a transparent electrode having a small size may have a more serious problem with the adhesive property, which generates ITO byte-based defects since the size of a cell of the structure is as small as a panel having fine pitch and high resolution.

In this case, from an experimental point of view, it can be seen that when the ITO byte-based defects of a “T” type arrangement is 100%, the ITO byte-based defects of a segment type arrangement is 41%, and the ITO byte-based defects of a ladder type arrangement is 33%.

According to the present invention, ITO defects can be reduced also when reducing the area of ITO by forming a transparent electrode, which can be formed to be transparent by using ITO, or the like. In addition, power consumption may be reduced to improve the efficiency of a plasma display panel by disposing the connection units 183 and 193 of the transparent electrodes 180a and 190a on the vertical barrier ribs 130a.

The first extension units 181 and 191, and the second extension units 182 and 192 can extend substantially parallel to a direction in which the horizontal barrier ribs 130b extend. The connection units 183 and 193 can extend in a direction in which the vertical barrier ribs 130a perpendicular to the horizontal barrier ribs 130b extend. In this case, the connection units 183 and 193 are disposed between the vertical barrier ribs 130a and the first substrate 111 so as to be covered by the top dielectric layer 115.

To reduce an area of the discharge space that is hidden by an electrode, if possible, at least part of the first extension units 181 and 191 and the bus electrodes 180b and 190b maybe disposed on the horizontal barrier ribs 130b. To achieve this, the horizontal barrier ribs 130b are formed in a double barrier rib structure. That is, the two horizontal barrier ribs 130b are disposed between discharge cells that are adjacent to each other in a direction in which the vertical barrier ribs 130a extend.

Accordingly, the ITO defects are reduced and power consumption may be reduced to improve the efficiency of a plasma display panel, by forming the transparent electrodes 180a and 190a in a ladder type arrangement and by disposing the connection units 183 and 193 on the vertical barrier ribs 130a.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A plasma display panel comprising:
a first substrate and a second substrate that are spaced apart from each other;
a plurality of barrier ribs dividing a space between the first substrate and the second substrate into a plurality discharge cells; and
a plurality of transparent electrodes disposed between the barrier ribs and the first substrate, wherein each of the transparent electrodes comprise:
a first extension unit and a second extension unit that extend to cross the respective discharge cells, and a connection unit connecting the first extension unit to the second extension unit, with at least a part each of the connection units being disposed on corresponding ones of the barrier ribs.

2. The plasma display panel of claim 1, wherein the first extension unit and the second extension unit extend substantially parallel to each other.

3. The plasma display panel of claim 1, wherein the barrier ribs comprise:
horizontal barrier ribs extending in a direction in which the first extension unit and the second extension unit extend; and
vertical barrier ribs extending in a direction in which the connection units extend.

4. The plasma display panel of claim 3, wherein each connection unit is disposed on a corresponding vertical barrier rib.

5. The plasma display panel of claim 3, wherein at least a part of each first extension unit is disposed on a corresponding horizontal barrier rib.

6. The plasma display panel of claim 3, wherein two horizontal barrier ribs are disposed between the discharge cells that are adjacent to each other in a direction in which the vertical barrier ribs extend.

7. The plasma display panel of claim 3, further comprising:
plural metallic bus electrodes that extends along corresponding horizontal barrier ribs, each metallic bus electrode being electrically connected to a corresponding first extension unit.

8. The plasma display panel of claim 1, wherein the plurality of transparent electrodes comprise:
an X electrode and a Y electrode that are disposed between the first substrate and the second substrate, and extend to cross the respective discharge cells,
wherein each of the X electrodes and the Y electrodes comprises a metallic bus electrode that extends along corresponding ones of the first extension units, each metallic bus electrode being electrically connected to the corresponding first extension unit.

9. The plasma display panel of claim 8, further comprising:
address electrodes that are disposed on the second substrate, and that extend in a perpendicular direction to a direction in which the X electrodes and the Y electrodes extend;
a first dielectric layer disposed on the first substrate so as to cover the X electrodes and the Y electrodes; and
a second dielectric layer disposed on the second substrate so as to cover the address electrodes.

10. The plasma display panel of claim 9, wherein the barrier ribs are disposed between the first dielectric layer and the second dielectric layer.

11. A plasma display panel comprising:
a first substrate and a second substrate that are spaced apart from each other;
X electrodes and Y electrodes that are disposed on a surface of the first substrate, the X electrodes and Y electrodes extending in parallel in a first direction;
address electrodes that are disposed on a surface of the second substrate, the address electrodes extending in a second direction perpendicular to the first direction in which the X electrodes and the Y electrodes extend;
barrier ribs dividing a space between the first substrate and the second substrate into a plurality discharge cells;
a first dielectric layer disposed on the first substrate so as to cover the X electrodes and the Y electrodes; and
a second dielectric layer disposed on the second substrate so as to cover the address electrodes, wherein each of the X electrodes and the Y electrodes comprise:
a transparent electrode and a bus electrode;
the transparent electrode comprises a first extension unit and a second extension unit that respectively extend in the first direction; and
a connection unit connecting the first extension unit to the second extension unit, wherein at least a part of the connection unit is disposed on a corresponding barrier rib extending in the second direction.

12. The plasma display panel of claim 11, wherein each of the barrier ribs comprise:
a horizontal barrier rib extending in the first direction; and
a vertical barrier rib extending in the second direction.

13. The plasma display panel of claim 12, wherein two horizontal barrier ribs are disposed between the discharge cells that are adjacent to each other in the second direction.

14. The plasma display panel of claim 12, wherein the connection unit is disposed on a correspond vertical barrier rib.

15. The plasma display panel of claim 12, wherein at least a part of the first extension unit is disposed on a correspond horizontal barrier rib.

16. The plasma display panel of claim 12, wherein the first extension unit and the second extension unit extend substantially parallel to each other.

17. The plasma display panel of claim 12, wherein the bus electrode is disposed on a surface of the first extension unit.

18. The plasma display panel of claim 12, wherein the bus electrode is disposed on a surface of the first extension unit and is disposed on a surface of a correspond horizontal barrier rib.

19. A plasma display panel having a first substrate and a second substrate that are spaced apart from each other, and a plurality of discharge cells disposed between said first and second substrates, each discharge cell being defined by a pair of horizontally extending barrier ribs and a pair of vertically extending barrier ribs, said display panel comprising:
X electrodes and Y electrodes that are disposed on a surface of the first substrate, the X electrodes and Y electrodes extending in parallel in a horizontal direction;
address electrodes that are disposed on a surface of the second substrate, the address electrodes extending in a vertical direction, wherein each of the X electrodes and the Y electrodes comprise:
a transparent electrode and a bus electrode;
the transparent electrode comprises a first extension unit and a second extension unit that respectively extend in the horizontal direction; and
a connection unit connecting the first extension unit to the second extension unit, wherein each said vertically extending barrier rib has a corresponding connection unit disposed thereon.

20. The plasma display panel of claim 19, wherein the bus electrode is disposed on a surface of the first extension unit and is disposed on a surface of a correspond horizontally extending barrier rib.
